(19) United States
(12) Patent Application Publication
(10) Pub. No.: US 2003/0014410 A1
(43) Pub. Date: Jan. 16, 2003

(54) Integrated service system and method

(76) Inventors: Han-Chao Lee, Taipei (TW); Yen-Liang Lu, WhaLieng (TW); Han-Kuan Yu, Taipei Hsien (TW)

Correspondence Address: MERCHANT & GOULD PC, P.O. BOX 2903, MINNEAPOLIS, MN, 55402-0903, US

(21) Appl. No.: 10/071,158

(22) Filed: Feb. 7, 2002

(30) Foreign Application Priority Data
Jul. 12, 2001 (TW) 90130328

(51) Int. Cl. G06F 7/00; G06F 17/30; G06F 9/00; G06F 9/54; G06F 15/163

(52) U.S. Cl. 707/8

(57) ABSTRACT

An integrated service system. The system includes a setting module, a service database, a matching module, and an execution module. The setting module sets a task flow, and the task flow includes at least one working step and content corresponding to the working step. The service database includes a plurality of services, and each of the services has an attribute. The matching module selects at least one service from the service database if the attribute corresponding to the service conforms to the content corresponding to the working step in the task flow. The execution module executes the working step of the task flow, and dynamically binds the service selected by the matching module to the working step.

### BACKGROUND OF THE INVENTION

1. Field of the Invention

The present invention relates to an integrated service system and method, and particularly to an integrated service system and method that provides appropriate services according to the user's intended task.

2. Description of the Related Art

Currently, in the process of constructing systems or applications, the systems are always designed from the designer's viewpoint, or developed by functional orientation. To operate in a system, users have to determine and select one of the services provided by the system to accomplish the user's desired purpose.

Additionally, systems are always designed for handling jobs in a single domain. However, since user's tasks almost always contain several steps or events in different domains, it is complicated for users to handle several systems and the operations thereof.

In the current solution, users must be very clear about the intended task and the steps contained within. For example, the task may contain three steps: first, arranging a meeting's attendees; second, finding a conference room; and third, preparing a projector. Users must operate three independent systems, such as a scheduling system, an ordering system for conference rooms, and an ordering system for necessary apparatus.

### SUMMARY OF THE INVENTION

It is therefore an object of the present invention to provide an integrated service system and method that provides appropriate services according to the user's intended task.

To achieve the above objects, the present invention provides an integrated service system and method. According to the embodiment of the invention, the integrated service system includes a setting module, a service database, a matching module, and an execution module.

The setting module sets a task flow, and the task flow includes at least one working step and content corresponding to the working step. The service database includes a plurality of services, and each of the services has an attribute. The matching module selects at least one service from the service database if the attribute corresponding to the service conforms to the content corresponding to the working step in the task flow. The execution module executes the working step of the task flow, and dynamically binds the service selected by the matching module to the working step.

According to the embodiment of the invention, the integrated service method, first, a plurality of services are provided in the system, and each of the services has an attribute. Then, a task flow is set, and the task flow includes at least one working step and content corresponding to the working step. Thereafter, at least one service is selected from the service database if the attribute corresponding to the service conforms to the content corresponding to the working step in the task flow. Finally, the working step in the task flow is executed, and the service selected by the matching module is dynamically bound to the working step.

The embodiment of the present invention further includes a display module for displaying the service selected by the matching module.

The embodiment of the present invention further includes an execution memorization module for memorizing the status of the task flow executed by the execution module.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram showing the system structure of an integrated service system according to the embodiment of the present invention;

FIG. 2 is a flow chart illustrating the operation of an integrated service method according to the embodiment of the present invention; and

FIG. 3 is a schematic diagram showing an example of service matching according to the embodiment of the present invention.

### DETAILED DESCRIPTION OF THE PREFERRED EMBODIMENT

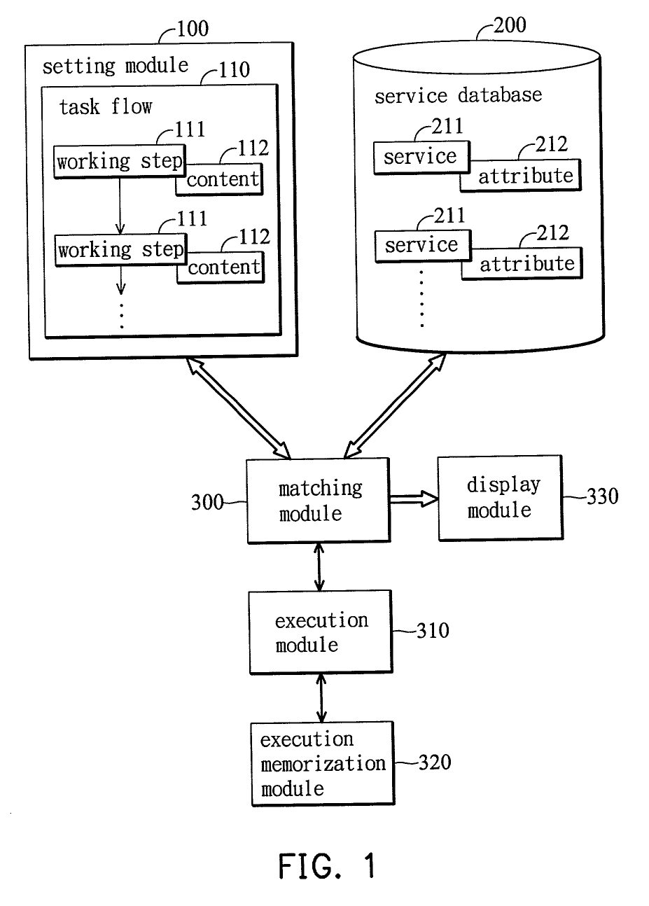

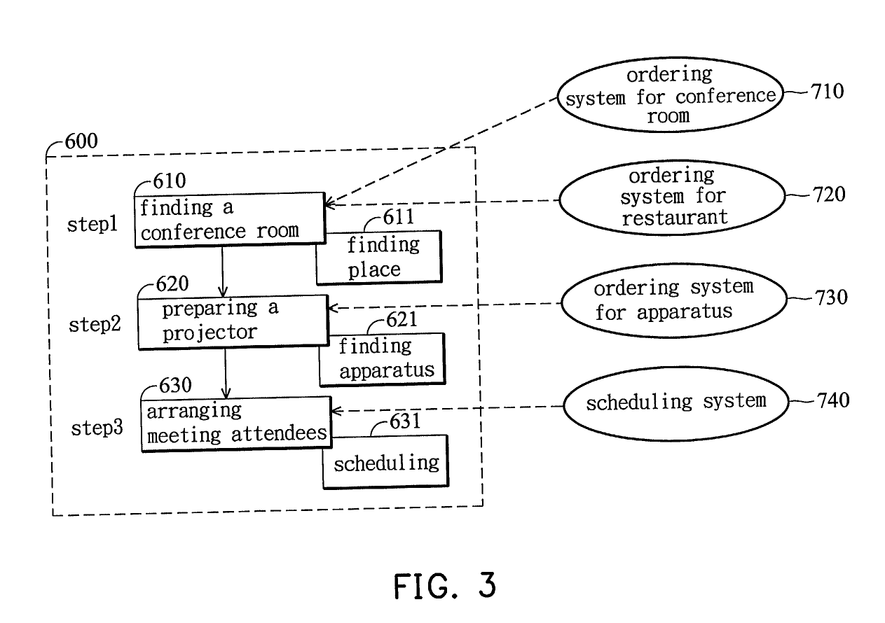

FIG. 1 shows the system structure of an integrated service system according to the embodiment of the present invention. Referring to FIG. 3, the system includes a setting module 100, a service database 200, a matching module 300, an execution module 310, an execution memorization module 320, and a display module 330.

The setting module sets a task flow 110. The task flow 110 includes at least one working step 111 and content 112 corresponding to the working step 111. In other words, the task flow 110 may be composed of one or several working steps 111, and the intention (or purpose) of each of the working steps 111 is recorded as the content 112 corresponding to the respective working step.

The service database 200 includes a plurality of services 211 with the same domain and/or different domains, each of the services 211 has an attribute 212. The attribute 212 records the function provided by the service 211 and/or the purpose achieved by the service 211.

The matching module 300 selects at least one service 211 from the service database 200 if the attribute 212 corresponding to the service 211 conforms to the content 112 corresponding to the working step 111 in the task flow 110. It should be noted that there may be one or several services whose corresponding attributes conform to the content of the working step. Further, the service may be integrated from multiple services.

When a user wants to run the task, the execution module 310 executes the task flow 110 in the setting module 100, that is to execute the working steps 111 in order, and dynamically bind the service 211 selected by the matching module 300 to the working step 111.

Further, when the execution module 310 executes the task flow 110, the execution memorization module 320 memorizes the status of the task flow 110, the status may dictate which working step is executed, and the related system parameters. It should be noted that if the execution is suspended or interrupted due to system failures or some factors, the execution module 310 may continue to execute the task flow 110 according to the status memorized by the execution memorization module 320.

Furthermore, the display module 330 displays the service 211 selected by the matching module 300 when the execution module 310 executes the task flow 110, to help users operate the system.

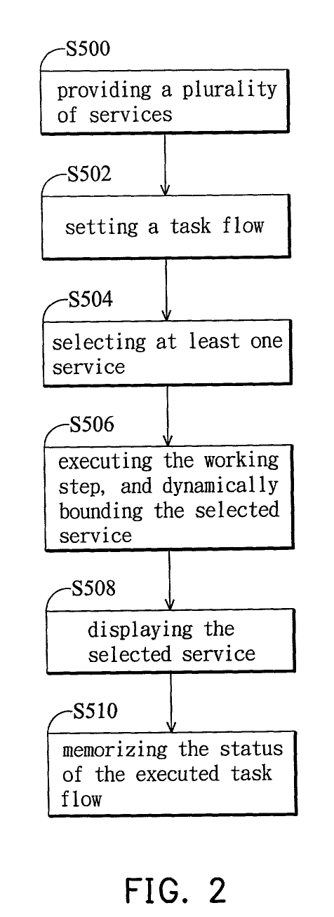

Next, FIG. 2 shows the operation of an integrated service method according to the embodiment of the present invention.

First, in steps S500, several services 211 with the same domain and/or different domains are provided, each of the services 211 has an attribute 212. Similarly, the attribute 212 records the function provided by the service 211 and/or the purpose achieved by the service 211.

Then, in step S502, a task flow 110 is set. The task flow 110 includes at least one working step 111 and content 112 corresponding to the working step 111. That is, the task flow 110 may be composed of one or several working steps 111, and the intention (or purpose) of each of the working steps 111 is recorded as the content 112 corresponding to respective working step.

Thereafter, in step S504, at least one service 211 is selected if the attribute 212 corresponding to the service 211 conforms to the content 112 corresponding to the working step 111 in the task flow 110.

Then, in step S506, the task flow 110 is executed, that is to execute the working steps 111 in order, and dynamically bind the selected service 211 to the working step 111. Then, in step S508, the selected service 211 is displayed when the task flow 110 is executed, to help users operate the system. Finally, in step S510, the status of the task flow 110 is memorized simultaneously. Similarly, the status may dictate which working step is executed, and the related system parameters.

It should be noted that the dictionary comparison method or the semantic comparison method can be used to determine whether the attribute 212 corresponding to the service 211 conforms to the content 112 corresponding to the working step 111 in the task flow 110.

Next, FIG. 3 shows an example of service matching according to the embodiment of the present invention, in which the task flow 600 includes three working steps, step 1, “finding a conference room” 610; step 2, “preparing a projector” 620; and step 3, “arranging attendees” 630, and the corresponding contents are “finding place” 611, “finding apparatus” 612, and “scheduling” 613.

When the task flow 600 is executed, the system will select services from the service database if the attribute 212 corresponding to the services conforms to the contents corresponding to the working steps, and then provides the services to user.

In this example, after the matching process according to the embodiment of the present invention, the selected services to step 1 are “ordering system for conference room” 710 and “ordering service system for restaurant” 720; the selected service to step 2 is “ordering system for apparatus” 730; and the selected service to step 3 is “scheduling system” 740.

Further, the working semantics and/or parameters can be transmitted between working steps, to control the operation of the next working step. In addition, the working steps can be added, deleted, and/or modified into a new task flow, thus the working steps may be inherited.

As a result, using the integrated service system and method according to the present invention can automatically match and provide appropriate services according to the user's intended task.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An integrated service system, comprising:
a setting module for setting a task flow, wherein the task flow comprises at least one working step and content corresponding to the working step;
a service database having a plurality of services, each of which has an attribute;
a matching module for selecting at least one service from the service database if the attribute corresponding to the service conforms to the content corresponding to the working step in the task flow; and
an execution module for executing the working step of the task flow, and dynamically binding the service selected by the matching module to the working step.

2. The system as claimed in claim 1 further comprising an execution memorization module for memorizing the status of the task flow executed by the execution module.

3. The system as claimed in claim 1 wherein the service is composed of a plurality of sub-services.

4. The system as claimed in claim 1 further comprising a display module for displaying the service selected by the matching module.

5. An integrated service method, comprising the steps of:
providing a plurality of services, wherein each of the services has an attribute;
setting a task flow, the task flow comprising at least one working step and content corresponding to the working step;
selecting at least one service if the attribute corresponding to the service conforms to the content corresponding to the working step in the task flow; and
executing the working step, and dynamically binding the service selected by the matching module to the working step.

6. The method as claimed in claim 5 further memorizing the status of the task flow executed by the execution module.

7. The method as claimed in claim 5 wherein the service is composed of a plurality of sub-services.

8. The method as claimed in claim 5 further displaying the service selected by the matching module.
